(19) United States
(12) Patent Application Publication
(10) Pub. No.: US 2026/0330370 A1
(43) Pub. Date: Oct. 22, 2026

(54) CONTENT MANAGEMENT SYSTEM AND CONTENT DISPLAY METHOD

(71) Applicant: Sharp Kabushiki Kaisha, Sakai City (JP)

(72) Inventor: Hiroya KAWASE, Sakai City (JP)

(21) Appl. No.: 19/699,454

(22) Filed: Jun. 5, 2026

Related U.S. Application Data
(63) Continuation of application No. PCT/JP2024/010914, filed on Mar. 21, 2024.

(51) Int. Cl. G06Q 10/0633; G06Q 20/20

(52) U.S. Cl. CPC G06Q 10/0633; G06Q 20/208

(57) ABSTRACT

A content management device includes an acquisitor to acquire identification information of commodities to be purchased and presence or absence of additional work of the commodities based on a desire of a purchaser of the commodities, a work time storage device to store the commodity identification information and an additional work time period required for the additional work in association with each other, an estimator to estimate a total work time based on a bagging time for bagging the commodities to be purchased and the additional work time period required for the additional work of the commodities requiring the additional work among the commodities to be purchased, a storage device to store content and a playback time period of the content, an extractor to extract content according to the total work time from the storage device. The content management device includes a content provider to cause a display device to display the content.

### BACKGROUND OF THE INVENTION

### Field of the Invention

The present invention relates to a content management system and a content display method.

### Description of Related Art

A system that displays content such as advertisements on a display device visible to customers for a waiting time during accounting in a store such as a supermarket or a convenience store is known. For example, barcodes attached to commodities are read with a scanner, and as the number of read commodities becomes greater, the waiting time becomes longer. According to such a system, the customer can wait for the waiting time during accounting while watching content.

A system that displays advertisements for a waiting time during service provision is known (for example, Patent Document 1). In the system, in a copy service, a waiting time is obtained by multiplying a processing time per sheet by the number of printed sheets, and an advertisement according to the waiting time is displayed.

### Patent Document

[Patent Document 1] Japanese Unexamined Patent Application, First Publication No. 2022-041451

### SUMMARY OF THE INVENTION

However, while a watching opportunity time in which a customer can watch content can be determined according to the quantity of commodities or services to be provided, the watching opportunity time also depends on factors other than the quantity of commodities or services to be provided. For this reason, it is preferable that content can be provided after the time of the watching opportunity is more accurately ascertained.

To solve the above-described problem, a content management system according to an aspect of the present invention includes an acquisitor configured to acquire commodity identification information of commodities to be purchased and presence or absence of additional work of the commodities based on a desire of a purchaser of the commodities, a work time storage device configured to store the commodity identification information and an additional work time period required for the additional work in association with each other, an estimator configured to estimate a total work time on the basis of a bagging time for bagging the commodities to be purchased and the additional work time period required for the additional work of the commodities requiring the additional work among the commodities to be purchased, and a content storage device configured to store content and a playback time period of the content, an extractor configured to extract content according to the total work time from the content storage device, and a content provider configured to cause a display device visible to a customer to display the extracted content.

A content display method according to an aspect of the present invention includes acquiring commodity identification information of commodities to be purchased and presence or absence of additional work of the commodities based on a desire of a purchaser of the commodities, estimating a total work time on the basis of a bagging time for bagging the commodities to be purchased read out from a work time storage device configured to store the commodity identification information and an additional work time period required for the additional work in association with each other and the additional work time period required for the additional work of the commodities requiring the additional work among the commodities to be purchased, extracting content according to the total work time from a storage device configured to store content and a playback time period of the content by referring to the storage device, and causing a display device visible to a customer to display the extracted content.

According to the present invention, it is possible to provide content after a time of a watching opportunity is more accurately ascertained.

### BRIEF DESCRIPTION OF THE DRAWINGS

FIG. 1 is a diagram illustrating an overview of a content management system S according to a first embodiment.

FIG. 2 is a schematic appearance diagram representing a state near a cash register counter where a POS terminal 30 is provided in a store.

FIG. 3 is a schematic functional block diagram representing functions of a content management device 50.

FIG. 4 is a diagram showing an example of content data stored in a content storage device 5021.

FIG. 5 is a diagram showing an example of commodity data stored in a commodity information storage device 5022.

FIG. 6 is a diagram showing an example of store clerk data stored in a store clerk information storage device 5023.

FIG. 7 is a diagram showing an example of customer data stored in a customer information storage device 5024.

FIG. 8 is a diagram showing an example of store-specific priority data stored in a priority item setting information storage device 5025.

FIG. 9 is a flowchart illustrating an operation of the content management device 50.

FIG. 10 is a diagram showing commodity data based on acquired commodity identification information.

FIG. 11 is a diagram showing an example of a priority ranking of content in sorting with commodities purchased by a customer.

FIG. 12 is a diagram showing an example of content that is displayed on a display device 70.

FIG. 13 is a schematic appearance diagram representing a state near a bagging table in a store.

FIG. 14 is a schematic functional block diagram representing functions of a content management device 50A.

FIG. 15 is a diagram showing an example of bagging time data stored in a customer information storage device 5024A.

FIG. 16 is a diagram showing an example of usage mode data stored in a usage mode storage device 5026A.

FIG. 17 is a flowchart illustrating an operation of the content management device 50A according to a second embodiment.

FIG. 18 is a schematic functional block diagram showing a configuration of a content management system Sb.

FIG. 19 is a schematic functional block diagram representing a configuration of a content management system Sc.

### DETAILED DESCRIPTION OF THE INVENTION

Hereinafter, embodiments of the present invention will be described with reference to the drawings.

### First Embodiment

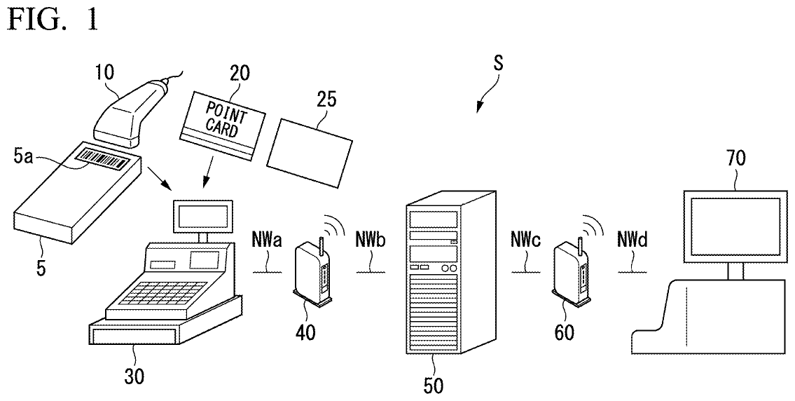

FIG. 1 is a diagram illustrating an overview of a content management system S according to a first embodiment of the present invention.

The content management system S includes a scanner 10, a member's card 20, a store clerk's card 25, a point of sales (POS) terminal 30, a router 40, a content management device 50, a router 60, and a display device 70.

The scanner 10 optically reads commodity identification information 5a attached to a commodity 5 and outputs a reading result to the POS terminal 30. Further, the scanner 10 optically reads customer identification information attached to the member's card 20 and outputs a reading result to the POS terminal 30. In addition, the scanner 10 optically reads store clerk identification information attached to the store clerk's card 25 and outputs a reading result to the POS terminal 30.

The member's card 20 is individually distributed to a customer who is registered as a member in a store. A barcode representing the customer identification information is printed on a surface of the member's card 20. The barcode may be one of a one-dimensional barcode and a two-dimensional barcode.

The store clerk's card 25 is individually distributed to each store clerk in a store. A barcode representing the store clerk identification information is printed on a surface of the store clerk's card 25. The barcode may be one of a one-dimensional barcode and a two-dimensional barcode. The store clerk's card 25 may have a name of the store clerk written thereon and may be used as a nameplate.

The POS terminal 30 is provided in a store that sells the commodity 5 and the like. The store may be a store which is a base that sells commodities and in which a customer can stay for settlement and may be, for example, one of a convenience store, a supermarket, a stand, a department store, a shopping center, a drugstore, and a retail store. In the embodiment, a case where the store is a convenience store will be described as an example.

Examples of a case where a customer stays in a store for settlement include a period during which a store clerk bags purchased commodities near the POS terminal 30, a period until a store clerk provides a commodity in response to an order or the like of the commodity from a customer to the store clerk who uses the POS terminal 30, and a period during which a customer bags commodities after settlement is made by the POS terminal 30. Examples of a case where a store clerk provides a commodity in response to an order or the like of the commodity from a customer include the following cases (1) to (4).

(1) A case where hot food is taken out of a hot showcase and is handed over to a customer

(2) A case where a commodity such as a soft ice cream (soft serve ice cream) is squeezed into a cone or the like in the form of an ingredient using a soft server (a server for soft serve ice cream) provided in a store and is handed to a customer

(3) A case where food such as a box lunch or a dish purchased by a customer is cooked using a cooking appliance such as a microwave oven

(4) A case where food ordered by a customer is cooked in a kitchen provided in a store and is served to the customer

(5) A case where a store clerk checks the content of a coupon, an exchange voucher, or the like presented from a customer, takes a commodity according to the coupon, the exchange voucher, or the like out of a shelf or a storage case, and hands over the commodity to the customer

The POS terminal 30 acquires the commodity identification information, the customer identification information, and the store clerk identification information output from the scanner 10, and transmits the acquired commodity identification information, customer identification information, and store clerk identification information to the content management device 50 via the router 40.

The POS terminal 30 acquires a price of the commodity on the basis of the read commodity identification information, calculates a settlement amount on the basis of the price of the commodity, and performs settlement processing according to payment from the customer.

The router 40 is connected to the POS terminal 30 in a communicative manner via a network NWa. Further, the router 40 is connected to the content management device 50 in a communicative manner via a network NWb. The network NWa and the network NWb may be one of a wired system and a wireless system or may be a combination of a wired system and a wireless system.

The content management device 50 is connected to the POS terminal 30 in a communicative manner via the router 40 and receives various kinds of data that are received from the POS terminal 30.

The content management device 50 is connected to the display device 70 in a communicative manner via the router 60 and transmits various kinds of data to the display device 70. For example, the content management device 50 can cause the display device 70 to display content by transmitting content to the display device 70.

The router 60 is connected to the content management device 50 in a communicative manner via a network NWc. Further, the router 40 is connected to the display device 70 in a communicative manner via a network NWd. The network NWc and the network NWd may be one of a wired system and a wireless system or may be a combination of a wired system and a wireless system.

The display device 70 is provided in the store. For example, the display device 70 is provided near the POS terminal 30 and is disposed at a position visible to a customer who performs settlement or the like in the POS terminal 30. The display device 70 may be attached, for example, to the POS terminal 30, and a display screen may be set in a direction visible to the customer. With this, the customer can watch content displayed on the display device 70 in a stay period.

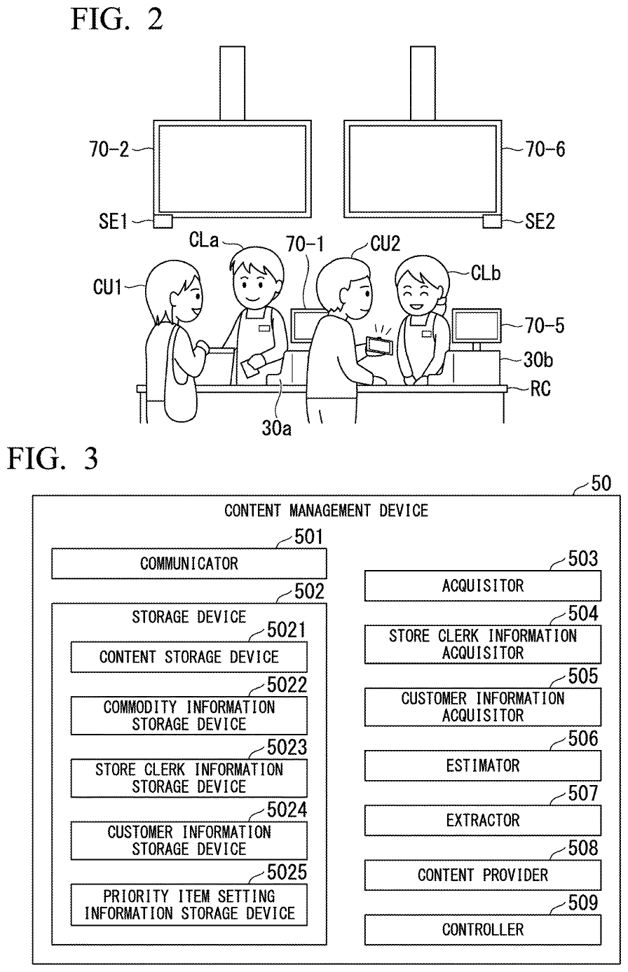

FIG. 2 is a schematic appearance diagram representing a state near a cash register counter where a POS terminal 30 is provided in a store.

In the drawing, two of a POS terminal 30a and a POS terminal 30b are provided as the POS terminal 30 on the cash register counter RC.

The POS terminal 30a is used by a store clerk CLa and reads a barcode attached to a commodity purchased by a customer CU1 or performs settlement processing. The customer CU1 can watch content that is displayed on at least one of a display device 70-1 attached to an upper portion of the POS terminal 30a and a display device 70-2 provided to be suspended from a ceiling above the POS terminal 30a.

A sensor SE1 is attached to a lower end portion of the display device 70-2. The sensor SE1 detects whether there is a customer near the POS terminal 30a and outputs a detection result to the POS terminal 30a or the content management device 50 via the router 40. The sensor SE1 can detect whether there is a customer (for example, the customer CU1) who is a purchaser near a cash register (POS terminal 30a) who reads a commodity with a scanner.

The POS terminal 30b is used by a store clerk CLb and reads a barcode attached to a commodity purchased by a customer CU2 or performs settlement processing. The customer CU3 can watch content that is displayed on at least one of a display device 70-5 attached to an upper portion of the POS terminal 30b and a display device 70-6 provided to be suspended from the ceiling above the POS terminal 30b.

A sensor SE2 is attached to a lower end portion of the display device 70-6. The sensor SE2 detects whether there is a customer near the POS terminal 30b and outputs a detection result to the POS terminal 30b or the content management device 50 via the router 40. The sensor SE2 can detect whether there is a customer (for example, the customer CU2) who is a purchaser near a cash register (POS terminal 30b) who reads a commodity with a scanner.

A customer can watch content that is displayed on such a display device 70 as long as the customer is near the POS terminal 30a or the POS terminal 30b, and can also watch content not only in a stay period but also in a period during which a commodity to be purchased is read with the scanner.

FIG. 3 is a schematic functional block diagram representing functions of the content management device 50.

The content management device 50 has a communicator 501, a storage device 502, an acquisitor 503, a store clerk information acquisitor 504, a customer information acquisitor 505, an estimator 506, an extractor 507, a content provider 508, and a controller 509.

The communicator 501 performs communication with the POS terminal 30 via the router 40 and performs communication with the display device 70 via the router 60

The storage device 502 stores various kinds of data. The storage device 502 is configured with a storage medium, for example, a hard disk drive (HDD), a flash memory, an electrically erasable programmable read only memory (EEPROM), a random access read/write memory (RAM), or a read only memory (ROM), or any combination of these storage mediums.

The storage device 502 can use, for example, a non-volatile memory.

The storage device 502 has a content storage device 5021, a commodity information storage device 5022, a store clerk information storage device 5023, a customer information storage device 5024, and a priority item setting information storage device 5025.

The content storage device 5021 stores content and a playback time period of the content.

The content storage device 5021 stores content data in which an advertisement information, a target, advertisement content (content), an item classification representing a classification of content, and a playback time period of the content are associated with one another.

The commodity information storage device 5022 stores commodity data in which commodity identification information attached to a commodity and an item indicating a classification allocated to the commodity are associated with each other.

The store clerk information storage device 5023 stores store clerk data in which a bagging time, a work time, and store clerk identification information are associated with one another.

In the customer information storage device 5024, customer identification information, date of birth, sex, and purchase data are stored.

The priority item setting information storage device 5025 stores store-specific priority data indicating a priority ranking determined for each store regarding content desired to be displayed with priority. The priority ranking represents that content given a higher priority ranking is extracted with priority. While a case where priority is more likely to be given as a numerical value of the priority ranking becomes smaller will be described, priority may be more likely to be given as the numeral value becomes greater.

The acquisitor 503 acquires a reading result obtained by reading commodity identification information attached to a commodity to be purchased with the scanner.

The store clerk information acquisitor 504 acquires store clerk identification information for identifying a store clerk who performs cash register reception.

The customer information acquisitor 505 acquires the customer identification information from the scanner 10 when the customer identification information is read from the member's card 20 presented by a customer who purchases a commodity, with the scanner 10 in the POS terminal 30.

The estimator 506 estimates a work time related to work that results from purchase of a commodity in a store and results from a process different from a scanning process in which the commodity identification information is read.

The work includes a preparation time for which the store clerk of the store prepares a commodity according to a request from a customer.

The preparation time may include at least one of (a) to (c) described below.
(a) A serving time until a store clerk takes hot food ordered from a customer out of a hot showcase and provides hot food to the customer
(b) A cooking time until a store clerk cooks a commodity ordered from a customer and hands over the commodity to the customer
(c) An exchange time until a store clerk prepares a commodity according to a coupon presented from a customer and hands over the commodity to the customer

The estimator 506 reads out a bagging time and a work time according to scanned commodities from the store clerk information storage device 5023 on the basis of the store clerk identification information acquired by the store clerk information acquisitor 504 and estimates a work time on the basis of the read-out time. The bagging time according to the scanned commodities may be obtained from the number of scanned commodities and a bagging time required for one commodity. An average bagging time per commodity may be used and a different bagging time may be used for each commodity.

The extractor 507 extracts, from the content storage device 5021, content according to a total time of the bagging times for bagging the commodities based on the scanned commodity identification information and the work time.

The extractor 507 extracts, from the content storage device 5021, content to which an item according to an item corresponding to the commodity identification information acquired by the acquisitor 503 is allocated, and extracts a combination of content which includes content having a high priority ranking of the extracted content and in which a total of playback time periods of the content to be combined is within the total time.

The content provider 508 causes a display device visible to the customer to display the extracted content.

For example, the content provider 508 causes the display device to display content having the highest priority ranking among the extracted content when the sensor SE1 or the sensor SE2 detects that there is a customer even after all pieces of the extracted content have been played back.

The content provider 508 displays content in a period during which the commodities are bagged by the store clerk of the store after settlement of the scanned commodities ends.

The communicator 501, the acquisitor 503, the store clerk information acquisitor 504, the customer information acquisitor 505, the estimator 506, the extractor 507, the content provider 508, and the controller 509 described above may be configured with, for example, a processing device such as a central processor (CPU) or a dedicated electronic circuit.

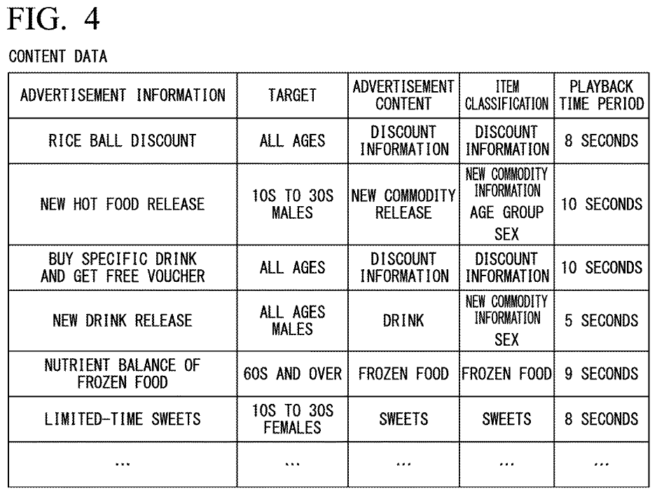

FIG. 4 is a diagram showing an example of content data stored in the content storage device 5021. In the content data, advertisement information, a target, advertisement content, an item classification, and a playback time period are included.

The advertisement information is information representing a title of an advertisement.

The target represents an attribute of a target customer for which content (advertisement information) is displayed. For example, “ALL AGES” represents that all ages are targets, and “10S TO 30S MALES” represents that males between ages of teens and thirties are targets.

The advertisement content is an example of content. The content may be one of a moving image and a still image. In the advertisement content, data of content that introduces a commodity or a service provided in a store to a customer is included. In the advertisement content of “RICE BALL DISCOUNT”, the content for explaining a condition under which or a period during which a rice ball is discounted may be included.

In the embodiment, while a case where content is an advertisement will be described, content may be other than an advertisement, and may be, for example, information regarding an area where a store exists, a weather forecast, a notice regarding disaster prevention, or recent news.

The item classification represents a classification of content. For example, an item classification “DISCOUNT INFORMATION” is allocated to advertisement information “RICE BALL DISCOUNT” and “BUY SPECIFIC DRINK AND GET FREE VOUCHER”, and this represents that the advertisement information is classified into information regarding a discount of a commodity. Further, item classifications “NEW COMMODITY INFORMATION” and “SEX” are allocated to advertisement information “NEW DRINK RELEASE”. Two items are allocated to the advertisement information, and this represents that a classification regarding a new commodity and a classification regarding sex are allocated. An item classification “FROZEN FOOD” is allocated to advertisement information “NUTRIENT BALANCE OF FROZEN FOOD”, and this represents that the advertisement information is classified into information regarding frozen food.

The item that is used in the item classification can be used as a tag or a keyword.

The playback time period represents a time for which display is performed on the display device. For example, a playback time period of advertisement information “NEW HOT FOOD RELEASE” is “10 SECONDS”, and this represents that a time from a playback start to a playback end of the advertisement information is ten seconds.

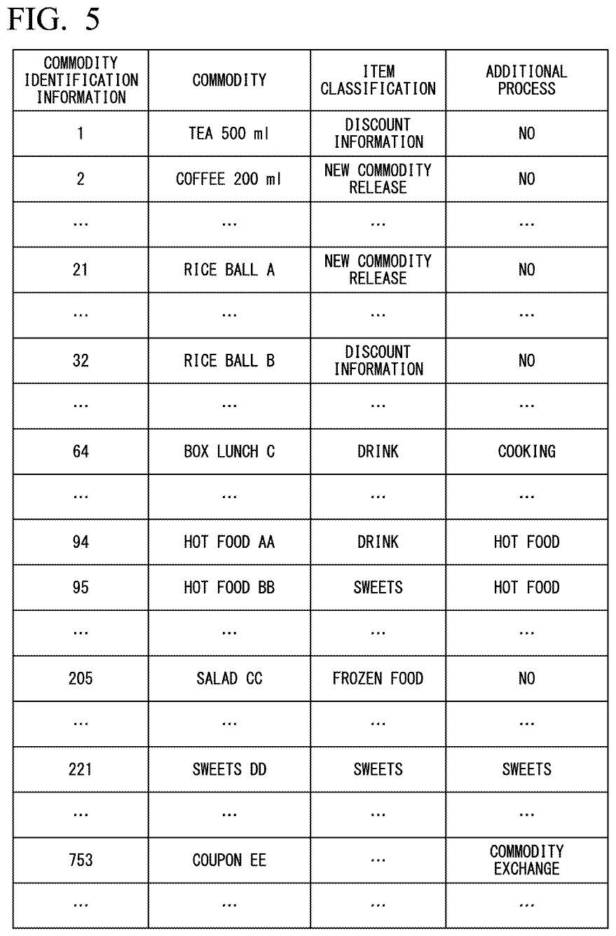

FIG. 5 is a diagram showing an example of commodity data stored in the commodity information storage device 5022. The commodity data is data in which commodity identification information attached to a commodity, the commodity, an item classification, and an additional process are associated with one another. The item classification is an item indicating a classification allocated to a commodity. The additional process represents a process other than a process of reading a barcode attached to a commodity with the scanner 10. The additional process is also referred to as additional work. Examples of the additional process include a process of preparing hot food, a process of preparing sweets, and a process of cooking such as heating food such as a box lunch using a cooking appliance.

For example, a commodity of commodity identification information “1” is “TEA 500 ml”, the item classification is “DISCOUNT INFORMATION”, and the additional process is “NO”. Because the additional process is “NO”, this indicates that the commodity of the commodity identification information “1” can be bagged after identification information is read by the scanner 10, without being subject to the additional process.

A commodity of commodity identification information “94” is “HOT FOOD AA”, the item classification is “DRINK”, and the additional process is “HOT FOOD”. Because the additional process is “HOT FOOD”, this indicates that the commodity of the commodity identification information “94” is subject to a process (for example, a process requiring the time of (a) described above) regarding hot food after identification information is read with the scanner 10.

In the commodity data, because the item classification is associated with each commodity, for example, when any commodity is purchased by a customer, the item classification according to the purchased commodity can be specified.

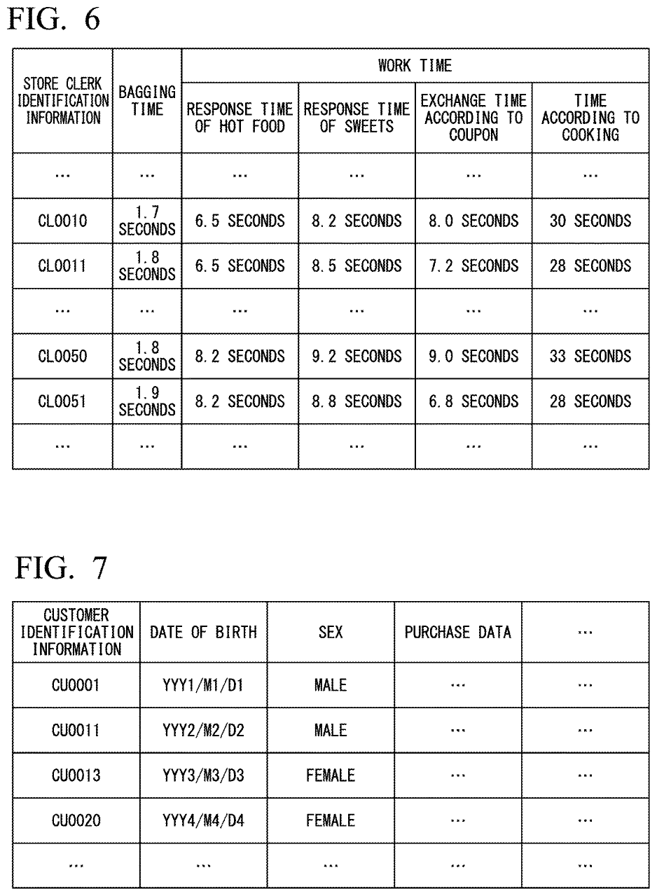

FIG. 6 is a diagram showing an example of store clerk data stored in the store clerk information storage device 5023. The store clerk data is data in which store clerk identification information, a bagging time, and a work time are associated with one another.

The store clerk identification information is information for individually identifying a store clerk.

The bagging time is a time required for putting a commodity for which reading of a barcode is completed with the scanner 10 in a shopping bag. Here, while a case where the bagging time uses an average bagging time per commodity will be described as an example, a different bagging time may be used for each commodity.

In the work time, a response time of hot food, a response time of sweets, an exchange time according to a coupon, and a time according to cooking are included.

It is considered that the bagging time and the work time are different for each store clerk according to a length or the like of a service period of the store clerk. For this reason, the bagging time or the work time may be determined according to the service period of the store clerk. Further, a time for which a store clerk actually performs bagging, a time for which a store clerk carries out a process other than scanning, or the like may be measured or the bagging time or the work time may be determined on the basis of the measured time and stored in association with the store clerk identification information.

The response time of hot food is a time until a store clerk takes hot food from a hot showcase and hands over hot food to a customer in response to an order from the customer, and represents a response time per hot food.

The response time of sweets is a time until a store clerk prepares sweets such as a soft ice cream and hands over sweets to a customer in response to an order from the customer, and represents a response time per sweets.

The exchange time according to the coupon is a time until a store clerk checks the content of a coupon, an exchange voucher, or the like presented from a customer, takes a commodity according to the coupon, the exchange voucher, or the like out of a shelf or a storage case, and hands over the commodity to the customer. The exchange time according to the coupon represents a response time per coupon.

The time according to cooking is a time until a store clerk heats food using a cooking appliance such as a microwave oven and then hands over food to a customer in response to an order from the customer, and represents a response time per commodity.

Here, in the work time, a kitchen time that is a time for which a store clerk cooks food ordered by a customer in a kitchen provided in a store and provides food to the customer may be included.

FIG. 7 is a diagram showing an example of customer data stored in the customer information storage device 5024.

The customer data includes, for example, customer identification information, date of birth, sex, and purchase data.

The customer identification information is information for individually identifying a customer. The customer identification information is individually allocated when a subscription for membership registration is received according to a demand from a customer. The date of birth represents the date of birth of a customer. The sex represents the sex of a customer. The purchase data is a log representing commodities purchased by a customer in the past. The purchase data may be data in which commodity identification information and purchase data and time are associated with each other.

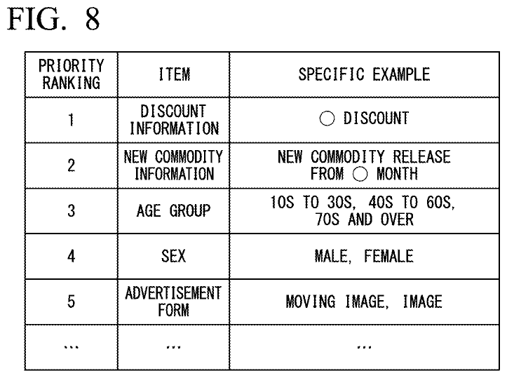

FIG. 8 is a diagram showing an example of store-specific priority data stored in the priority item setting information storage device 5025. The store-specific priority data shown in FIG. 8 is data set for a certain store, and for other stores, a priority ranking, an item, and a specific example are determined according to a policy or a desire of each store.

Priority data is, for example, data in which a priority ranking, a target item, and a specific example are associated with one another. The priority ranking is a ranking that is determined from 1 in order. Here, 1 is a highest ranking, and this indicates that the ranking is lowered as the number increases. The item is an item desired to be given priority, and can be determined from an advertisement (tag or keyword), an attribute (age range or sex), or the like that can be used as an item classification. The specific example indicates the detailed content of an item classification.

Here, an item classification “DISCOUNT INFORMATION” and a specific example “O DISCOUNT” are associated with a priority ranking “1”.

Here, while a waiting time is different depending on the number of purchased commodities, the number and kinds of commodities requiring an additional process, or the like, a store has a demand to desire to display content having as a high appeal effect as possible for the waiting time determined in such a manner. For this reason, the store can determine content desired to be displayed with priority during the limited waiting time from the viewpoint of the item classification and the specific example.

Next, an operation of the content management system S will be described.

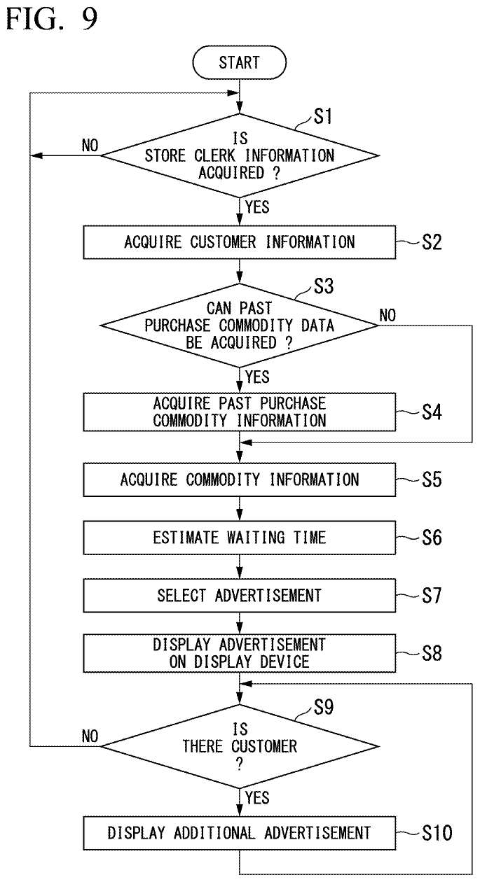

FIG. 9 is a flowchart illustrating an operation of the content management device 50.

Here, a case where a store is a convenience store will be described as an example.

### Step S1: Acquisition of Store Clerk Information

When a commodity to be purchased from commodities on display in a store is put in a shopping basket and is carried to a cash register counter by a customer, a store clerk reads the barcode attached to the store clerk's card 25 carried with him/her with the scanner 10.

The scanner 10 reads the barcode attached to the store clerk's card 25 of the store clerk and transmits a reading result as the store clerk identification information to the POS terminal 30. When the store clerk identification information is acquired, the POS terminal 30 transmits the store clerk identification information to the content management device 50.

The store clerk information acquisitor 504 of the content management device 50 determines whether or not the store clerk identification information is acquired from the POS terminal 30. When the store clerk identification information is not acquired, the store clerk information acquisitor 504 executes the processing of Step S1 again after a given waiting time has elapsed.

On the other hand, when the store clerk identification information is acquired, the store clerk information acquisitor 504 proceeds the processing to Step S2.

The store clerk information is stored in a content management server and is synchronized with the barcode of the nameplate. The store clerk information includes past customer service data, and the past customer service data is used in estimating a time required for a customer service. It is assumed that the time required for the customer service is from when accounting is completed until bagging ends completely.

### Step S2: Acquisition of Customer Information

In Step S2, the POS terminal 30 acquires the customer information. The acquisition of the customer information can be performed by obtaining the customer identification information corresponding to the barcode when the barcode of the member's card 20 is read with the scanner 10. Further, in the acquisition of the customer information, the member's card 20 may not be read, and one customer group button for inputting an attribute of a customer disposed in the POS terminal 30 may be pressed, and accordingly, the customer information may be acquired by acquiring the attribute of the customer allocated to the customer group button. The customer group buttons are provided in such a manner that the customer group buttons with ages according to ages such as “10 AND BELOW”, “10S”, “20S”, “30S”, “40 TO 50S”, and “60S AND OVER” are divided into male and female. A store clerk estimates the sex and the age from the appearance of the customer and presses the customer group button according to the estimation result.

When the customer information is acquired, the POS terminal 30 transmits the acquired customer information to the content management device 50. The customer information acquired herein is one of the customer identification information and the attribute of the customer.

When the customer identification information can be acquired by reading the member's card 20 with the scanner 10, the customer information acquisitor 505 of the content management device 50 can obtain the customer information by referring to the customer information storage device 5024 on the basis of the customer identification information and reading out the date of birth and the sex registered in the membership registration.

### Step S3: Determination on Acquisition Possibility of Past Purchase Data

In Step S3, the controller 509 determines whether past purchase data can be acquired. In Step S2, when the barcode of the member's card is read with the scanner 10, the controller 509 determines that the purchase data can be acquired (Step S3—YES). In this case, the processing proceeds to Step S4.

On the other hand, in Step S2, when the customer attribute is obtained by pressing the customer group button, the controller 509 determines that the past purchase data cannot be acquired (Step S3—NO). In this case, the processing proceeds to Step S5.

### Step S4: Acquisition of Past Purchase Commodity Information

In Step S3, when the customer identification information is obtained, the customer information acquisitor 505 acquires past purchase commodity information by referring to the customer information storage device 5024 and reading out the purchase data corresponding to the customer identification information.

### Step S5: Acquisition of Commodity Information

In Step S5, the store clerk takes out one commodity in the shopping basket and reads the barcode attached to the taken-out commodity with the scanner 10. The scanner 10 reads the barcode attached to the commodity and outputs a reading result as the commodity identification information to the POS terminal 30.

The store clerk places the commodity of which the barcode is read, on the cash register counter and sequentially reads a barcode of a commodity with the scanner 10 until there is no commodity in the shopping basket.

With this, the POS terminal 30 sequentially acquires the commodity identification information each time the barcode is read with the scanner 10. The POS terminal 30 transmits the acquired commodity identification information to the content management device 50 each time the commodity identification information is acquired. The acquisitor 503 of the content management device 50 sequentially acquires the commodity identification information from the POS terminal 30. The controller 509 of the content management device 50 stores the received commodity identification information as the purchase data of the customer information storage device 5024.

Here, a commodity that is prepared and provided by the store clerk such as hot food or a soft ice cream other than the commodities put in the shopping basket may be ordered from the customer verbally. In such a case, the store clerk reads a barcode corresponding to the ordered commodity from a list of barcodes printed on a print medium for the ordered commodity. With this, the POS terminal 30 acquires commodity identification information for the commodity that is prepared and provided by the store clerk such as hot food or a soft ice cream and transmits the commodity identification information to the content management device 50. The acquisitor 503 of the content management device 50 acquires the commodity identification information for the commodity such as hot food or a soft ice cream.

### Step S6: Estimation of Waiting Time

When each commodity to be purchased is read, the store clerk presses a “SUBTOTAL” button on the POS terminal 30. The POS terminal 30 performs settlement processing in response to the press of the “SUBTOTAL” button. When the “SUBTOTAL” button is pressed, the POS terminal 30 transmits a registration completion signal representing that the registration of the commodity identification information is completed, to the content management device 50.

When the registration completion signal is received, the estimator 506 of the content management device 50 estimates a stay time. In the stay time, the bagging time and the work time are included. Hereinafter, the stay time may be referred to as a waiting time. The stay time is a time for which a watching opportunity capable of having the customer watch content arises.

For example, the estimator 506 estimates the waiting time on the basis of the number of pieces of scanned commodity identification information, an order of a commodity requiring a process other than scanning, and the store clerk identification information.

The estimator 506 can obtain the number of pieces of scanned commodity identification information by counting the number of pieces of commodity identification information acquired by the acquisitor 503 in Step S3.

The estimator 506 calculates a time for bagging the commodities to be purchased by reading out the bagging time and the work time corresponding to the store clerk identification information acquired by the store clerk information acquisitor 504 and multiplying the read-out bagging time by the number of pieces of commodity identification information.

The estimator 506 calculates a time according to an order of a commodity requiring process other than scanning. For example, the estimator 506 extracts a target commodity for which a work time arises, among the commodity identification information acquired by the acquisitor 503 in Step S3. For example, the estimator 506 refers to the commodity information storage device 5022 for an additional process corresponding to the commodity identification information acquired by the acquisitor 503, and extracts a commodity corresponding to the additional process “HOT FOOD”, “SWEETS”, “COOKING”, or “COMMODITY EXCHANGE”. Then, the estimator 506 refers to the store clerk information storage device 5023 on the basis of the extracted additional process and adds a work time according to the commodity corresponding to the additional process. For example, when commodity identification information of a commodity “HOT FOOD AA” is acquired, the additional process of the commodity is “HOT FOOD”, and “RESPONSE TIME OF HOT FOOD” corresponding to store clerk identification information is read out among the work times of the store clerk information storage device 5023 on the basis of the additional process “HOT FOOD”. When store clerk identification information “CL0010” is acquired in Step S1, the estimator 506 reads out “6.5 SECONDS” of “RESPONSE TIME OF HOT FOOD” corresponding to the store clerk identification information “CL0010”. Similarly, when there are commodities corresponding to other additional processes (for example, “SWEETS” and “COMMODITY EXCHANGE”) among the commodity identification information acquired in Step S5, the work time is read out for each commodity. Then, when the work times are read out, the estimator 506 can estimate a time according to the order of the commodities requiring the processes other than scanning by totaling the respective work times.

The estimator 506 calculates the waiting time by totaling the time for bagging the commodities to be purchased and the time according to the order of the commodities requiring the processes other than scanning.

Here, because the bagging time and the work time according to the store clerk identification information are obtained, in spite of a time taken by human work, the waiting time according to the store clerk can be obtained taking into consideration the experience or the service period of the store clerk.

A specific example of a case where a waiting time is calculated is described below.

### Example

Customer information: 20s male

Purchased commodity: one bottle of tea 500 ml, two rice balls (no cooking with heat), one hot food, and one salad

Store clerk information: From data of 20 times in the past, the time required for bagging is 1.5 seconds per commodity. The response time of hot food is 18 seconds from when hot food is taken out until hot food is bagged.

Estimated waiting time: (bagging of commodities other than hot food) 1.5 seconds×4 commodities=6 seconds
(the time required for hot food) 18 seconds
the total is 6 second+18 seconds=24 seconds

### Step S7: Selection of Advertisement

When the stay time (waiting time) is obtained, in Step S7, the extractor 507 of the content management device 50 extracts content according to the stay time and relevant to the purchase commodity information of the customer.

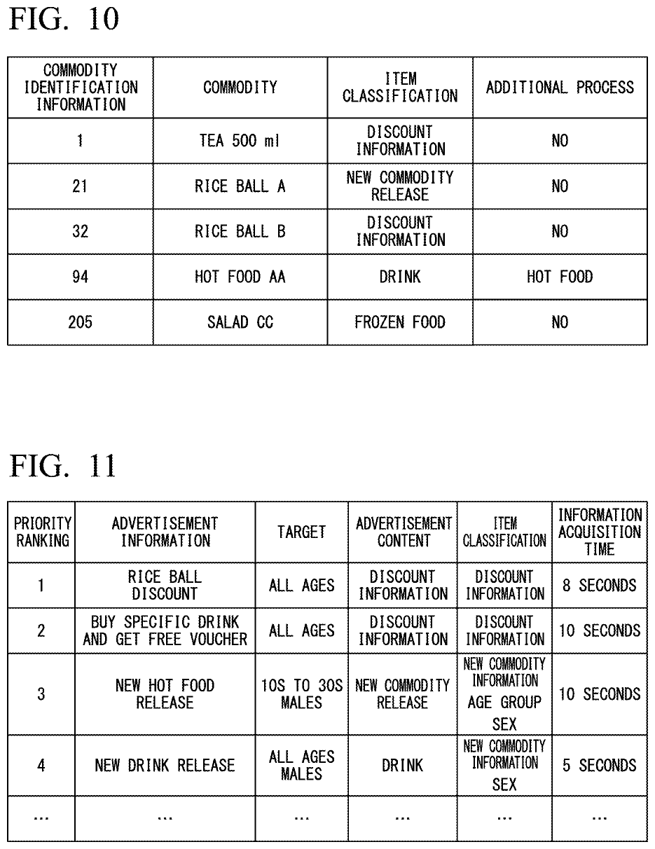

Here, FIG. 10 is a diagram showing commodity data based on the commodity identification information acquired in Step S5. Here, when the customer purchases five commodities, the commodity data for the purchased commodities is extracted. The item classifications of the extracted commodity data are “DISCOUNT INFORMATION”, “NEW COMMODITY RELEASE”, “DISCOUNT INFORMATION”, “DRINK”, and “FROZEN FOOD”. The customer information acquired in Step S2 is “20S MALE”.

Then, it is assumed that the extractor 507 sorts and determines with the purchase commodity information of the customer on the basis of priority item setting information stored in the priority item setting information storage device 5025.

Here, as a method of providing an appropriate advertisement to the customer, correlation of the customer information obtained in Step S2 and information of the commodities purchased by the customer obtained in Step S3 with information included in an advertisement to be displayed is possible.

Examples of a correlation method of information include the following methods (A) to (C).

### (A) Correlation by Items

Several items such as “DRINK” and “FROZEN FOOD” are correlated with commodities and advertisements in advance, and an advertisement of a tag pertaining to a commodity purchased by a customer is provided.

### (B) Correlation from Another Piece of Customer Information

Data regarding other commodities that are purchased together when another customer that purchases the same commodity as a commodity indicated by the commodity identification information obtained in Step S5 purchases the commodity is collected, and an advertisement of a commodity that is highly frequently purchased together is provided.

### (C) Correlation from Shopping Trend of Customer

By imaging a customer who visits a store is imaged with a camera provided at an entrance of the store, performing face authentication using a captured face image of the customer, and tracking movement in the store during shopping with a plurality of cameras provided in the store, a selling area where the customer is stopped for a long time or a selling area having a shelf where a commodity taken out and appreciated by the customer is displayed is extracted. Then, an advertisement relevant to the selling area is provided.

An example where an advertisement correlated with the purchase commodity information of the customer is selected with the priority item setting in FIG. 8 described above as an example is described below.

FIG. 11 is a diagram showing an example of a priority ranking of content when content data corresponding to an item classification allocated to a commodity purchased by a customer is extracted and sorting is made according to a priority ranking for each item set by priority item setting shown in the FIG. 8 according to the item classification allocated to the extracted content data.

For example, because the item classification allocated to the purchased commodity “TEA 500 ml” is “DISCOUNT INFORMATION” (see FIG. 10), a record of content data (see FIG. 4) to which the item classification “DISCOUNT INFORMATION” is allocated is extracted. Here, for example, advertisement information “RICE BALL DISCOUNT” and advertisement information “BUY SPECIFIC DRINK AND GET FREE VOUCHER” to which the item classification “DISCOUNT INFORMATION” is allocated are extracted.

Further, because the item classification allocated to the purchased commodity “RICE BALL A” is “NEW COMMODITY RELEASE” (see FIG. 10), a record of content data (see FIG. 4) to which the item classification “NEW COMMODITY RELEASE” is allocated is extracted. Here, for example, advertisement information “NEW HOT FOOD RELEASE” and advertisement information “NEW DRINK RELEASE” to which the item classification “NEW COMMODITY RELEASE” is allocated are extracted.

In this manner, each record of content according to each commodity purchased by the customer is extracted.

Then, when the extracted records are sorted according to the priority ranking on the basis of the priority item setting (FIG. 8), the result shown in FIG. 11 is obtained. Here, advertisement information (for example, “RICE BALL DISCOUNT” and “BUY SPECIFIC DRINK AND GET FREE VOUCHER”) to which the item classification “DISCOUNT INFORMATION” is allocated has a higher ranking, and subsequently, advertisement information (for example, “NEW HOT FOOD RELEASE” and “NEW DRINK RELEASE”) to which the item classification “NEW COMMODITY INFORMATION” is allocated is arranged. Here, when there are a plurality of pieces of advertisement information to which the same item classification is allocated, the advertisement information is sorted such that the advertisement information to which a plurality of item classifications are allocated has a higher ranking among the advertisement information to which the same item classification is allocated.

Then, advertisements are extracted in a descending order of the priority ranking among the priority rankings of content after sorting such that a combination has a time within a range of an estimated waiting time.

For example, as shown in FIG. 11, when the priority rankings of content after sorting are obtained, and when a priority ranking 1 (RICE BALL DISCOUNT), a priority ranking 2 (BUY SPECIFIC DRINK AND GET FREE VOUCHER), and a priority ranking 3 (NEW HOT FOOD RELEASE) are extracted, the following expression is established.

priority ranking 1 (8 seconds)+priority ranking 2 (10 seconds)+priority ranking 3 (10 seconds)=28 seconds

For this reason, the time is not within 24 seconds obtained as the waiting time. As a result, the extractor 507 does not employ the combination.

Next, the priority ranking 1 (RICE BALL DISCOUNT), the priority ranking 2 (BUY SPECIFIC DRINK AND GET FREE VOUCHER), and a priority ranking 4 (NEW DRINK RELEASE) are extracted, the following expression is established.

priority ranking 1 (8 seconds)+priority ranking 2 (10 seconds)+priority ranking 4 (5 seconds)=23 seconds

For this reason, the time is within 24 seconds obtained as the waiting time. As a result, the extractor 507 employs the combination. The extractor 507 can obtain a combination capable of most efficiently providing information within the estimated waiting time by extracting the combination as a final extraction result.

### Step S8: Display of Advertisement

When the combination of the content is extracted by the extractor 507, the content provider 508 causes the display device 70 to display the extracted content such that the content is played back in order according to the priority rankings.

Here, after pressing the “SUBTOTAL” button in Step S6, the store clerk performs settlement processing using the POS terminal 30 in response to the payment of the customer, performs bagging, and performs an additional process such as ordered hot food preparation or sweets preparation. Here, when the “SUBTOTAL” button is pressed in Step S6, processing of Steps S7 to S9 is executed, and content is displayed on the display device 70. The display of the content is started at a timing at which the store clerk bags each commodity or performs an additional process. For this reason, the customer can wait while watching the content when the store clerk is bagging the commodities or is preparing hot food. Further, because the content has a playback time period according to the number of purchased commodities or a time necessary for carrying out an additional process, it is possible to have the customer watch the content for the playback time period matching the waiting time.

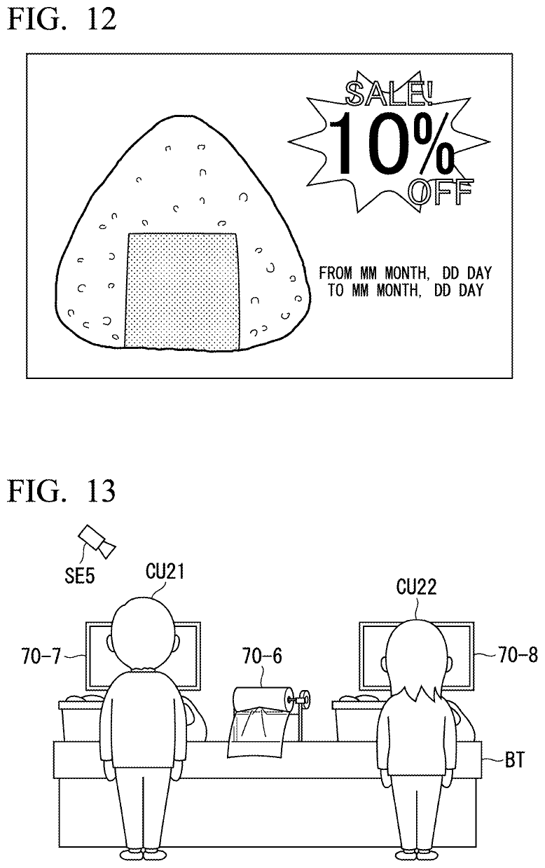

FIG. 12 is a diagram showing an example of content that is displayed on the display device 70.

### Step S9: Detection of Customer

At a given time (for example, five seconds) before a timing at which the playback of the content extracted in Step S8 ends, the controller 509 acquires a detection result from the sensor SE1 or the sensor SE2, and determines whether cash register reception is not completed and the customer is in the vicinity of the cash register counter on the basis of the detection result. When bagging, provision of hot food, or the like is not completed, because cash register reception is not completed, the customer stays in the vicinity of the cash register counter. When cash register reception is completed, the customer moves to a position away from the cash register counter, and thereafter, leaves the store.

When there is no customer in the vicinity of the cash register counter (Step S9—NO), the controller 509 instructs the content provider 508 not to display additional content. With this, the content provider 508 causes the display device to display content determined in advance until a next customer performs cash register reception, without displaying additional content. Then, the controller 509 transits the processing to Step S1.

### Step S10: Display of Additional Content

On the other hand, when there is the customer in the vicinity of the cash register counter (Step S9—YES), the controller 509 instructs the content provider 508 to display additional content. When the instruction is received, the content provider 508 causes the display device 70 to display content that is not yet displayed among the content extracted in Step S7. Here, the content provider 508 may cause the display device to display content having a highest priority ranking among the content that is extracted by the extractor 507 and not displayed.

In the embodiment described above, while a case where a time when hot food is ordered is taken into consideration as a work time has been described, when there is an order for sweets from a customer, a waiting time may be calculated such that a response time according to the sweets is included in a work time. When a coupon is presented from a customer, a barcode attached to the coupon may be read with the scanner 10, an exchange time according to the coupon corresponding to commodity identification information indicated by the read barcode may be read out, and a waiting time may be calculated such that the exchange time is included in a work time. Further, when there is a commodity to which an additional process “COOKING” is associated, among the purchased commodities, a waiting time may be calculated such that a time according to cooking is included in a work time.

### Second Embodiment

Next, a second embodiment will be described.

In the first embodiment, while a case where the store clerk bags the purchased commodities has been described, in the second embodiment, a case where the customer himself or herself performs bagging will be described. As a case where the customer himself or herself performs bagging, for example, there is a store of a form in which, after commodities are scanned with the scanner 10 and settlement is completed in the cash register counter, the customer carries a basket in which the commodities of which settlement is completed are put, to a bagging table disposed at a position in the vicinity of the cash register counter and behind the POS terminal, and the customer himself or herself bags the commodities. Examples of a store of such a form include a supermarket and a drugstore. In regard to the bagging table, there is a case where a table surface of a part of the cash register counter is expanded and a space for the customer to perform bagging is secured or a case where a bagging table is provided at a place away from the cash register counter.

In the store of such a form in which the customer himself or herself performs bagging, it is not necessary to take into consideration fluctuation of an estimated waiting time according to a work speed of a store clerk, but it is not necessary to take into consideration a bagging time of the customer. Accordingly, a bagging time according to an age group and sex is estimated by acquiring the attribute such as an age group or sex acquired in Step S2 and data of a time required for bagging different between customers.

On the bagging table, commodities may be packed in a shopping bag or commodities may be put in a rolled bag and bagged. In this way, when there is a commodity that is likely to be put in a rolled bag, a time for putting the commodity in the rolled bag arises. For this reason, a total time required for bagging is prolonged, compared to when a commodity is bagged without being put in a rolled bag. When the number of commodities that should be put in the rolled bag increases, the time for bagging is extended.

In the second embodiment, when the customer performs bagging, a process of putting a commodity in a rolled bag is regarded as an additional process, and a stay time is obtained by adding a time required for the additional process to the time required for bagging. Here, because the customer stays in a period during which the customer performs bagging on the bagging table, it is possible to have the customer watch content for the stay time by causing a display device provided on the bagging table to display the content.

FIG. 13 is a schematic appearance diagram representing a state in the vicinity a bagging table in a store.

In the drawing, a customer CU21 and a customer CU22 is bagging commodities of which settlement is completed, on a bagging table BT. On the bagging table BT, a display device 70-7 and a display device 70-8 are provided in parallel according to a position where bagging is performed. The display device 70-7 is provided at a position on the front when viewed from a position where the customer CU21 performs bagging. The customer CU21 can perform bagging while watching content that is displayed on the display device 70-7. Similarly, the display device 70-8 is provided at a position on the front when viewed from a position where the customer CU22 performs bagging. The customer CU22 can perform bagging while watching content that is displayed on the display device 70-8.

A rolled bag is attached to a holder between the display device 70-7 and the display device 70-8, and a customer that performs bagging can use the rolled bag as necessary. The rolled bag has connected bags wound along a longitudinal direction and can be used as one bag by pulling out a tip portion and separating a bag along a perforation. Such a rolled bag may be used for accommodating fresh food such as meat or fish placed on a tray and sealed with a transparent film. By putting fresh food in the rolled bag, even when moisture or the like leaks from a commodity, it is possible to restrain moisture or the like from leaking outside the rolled bag.

A sensor SE5 that detects whether there is a customer is provided in the vicinity of the bagging table BT. The sensor SE5 is, for example, a camera, and images an area including the bagging table BT and detects whether there is a customer according to whether an image according to a customer who performs bagging on the bagging table BT can be extracted from a captured image. The sensor SE5 detects that there is a customer when an image according to a customer is extracted, and detects that there is no customer when an image according to a customer is not extracted.

In the second embodiment, while the configuration of the content management system S is similar, the functions of the content management device 50 are different. Thus, the configuration of the content management system S will not be repeated, and differences in the content management device 50 will be primarily described.

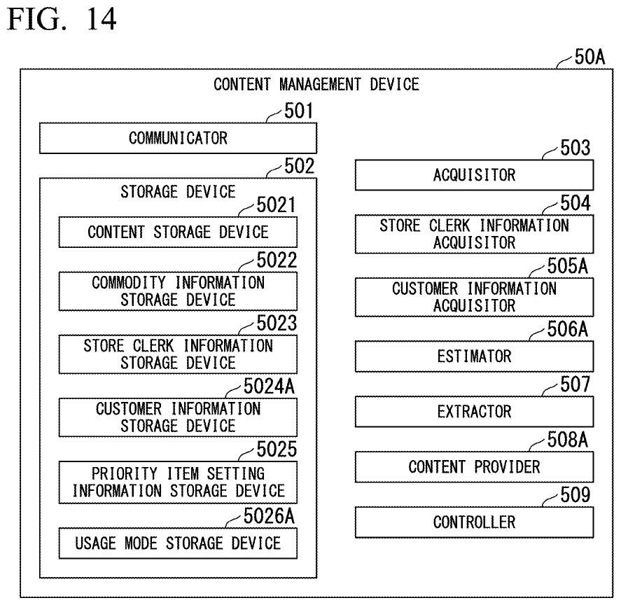

FIG. 14 is a schematic functional block diagram representing functions of a content management device 50A. In FIG. 14, portions common to the content management device 50 of FIG. 3 are represented by the same reference numbers, and description thereof will not be repeated.

The content management device 50A is different from the content management device 50 in that a customer information storage device 5024A, a usage mode storage device 5026A, a customer information acquisitor 505A, an estimator 506A, and a content provider 508A are provided.

The customer information storage device 5024A stores bagging time data in which a time for which commodities are bagged in a shopping bag, a time for which a commodity is put in a rolled bag, and an attribute of a customer are associated with one another.

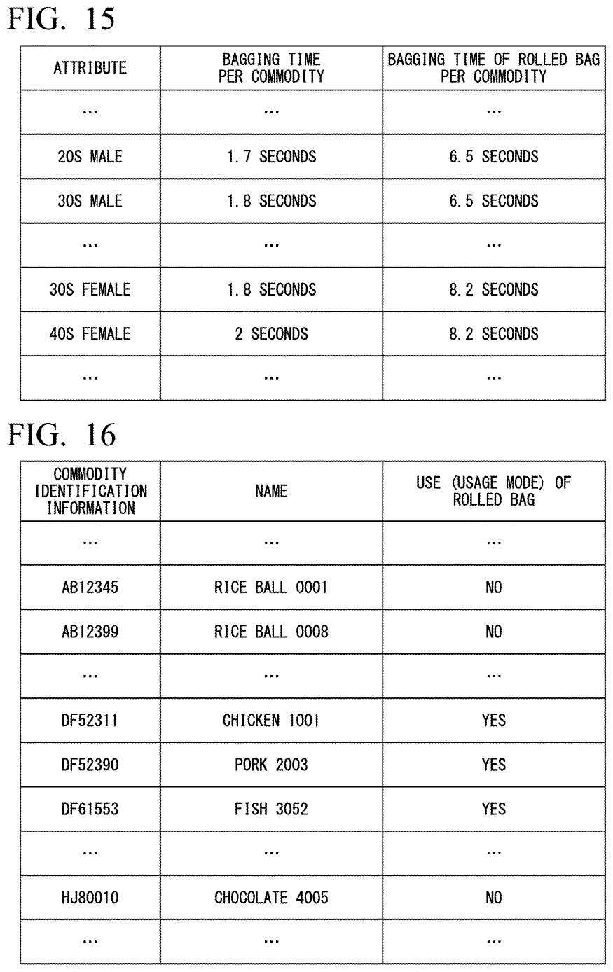

FIG. 15 is a diagram showing an example of bagging time data stored in the customer information storage device 5024A. In the bagging time data, attribute information, a bagging time per commodity, and a bagging time of a rolled bag per commodity are associated with one another. For example, in the case of an attribute “30S FEMALE”, a bagging time per commodity in bagging commodities in a shopping bag is “1.8 SECONDS”, and a time per commodity in putting commodities in a rolled bag is “8.2 SECONDS”.

The usage mode storage device 5026A stores usage mode data in which commodity identification information and a usage mode indicating a likelihood of being put in a rolled bag are associated with each other.

FIG. 16 is a diagram showing an example of usage mode data stored in the usage mode storage device 5026A. The usage mode data is data in which commodity identification information, a name of a commodity, and usage of a rolled bag are associated with one another. The usage of the rolled bag is information indicating whether a commodity is likely to be put in a rolled bag. In the usage of the rolled bag, “YES” represents that there is a likelihood of using the rolled bag, and “NO” represents that the rolled bag is not intended to be used.

For example, a name “RICE BALL 0001” is associated with commodity identification information “AB12345”, and because the usage of the rolled bag is “NO”, this represents that the usage of the rolled bag is not intended. Further, a name “CHICKEN 1001” is associated with commodity identification information “DEF5311”, and because the usage of the rolled bag is “YES”, this represents that there is a likelihood of the usage of the rolled bag.

The customer information acquisitor 505A acquires attribute information of a customer who performs bagging.

The estimator 506A estimates a work time including a time for which a part of commodities among commodities are packed in the rolled bag by the customer and a time for which the commodities are bagged in a shopping bag by the customer, after settlement of the commodities ends.

The estimator 506A obtains a first time for which the customer performs bagging, on the basis of the number of commodities based on the commodity identification information acquired by the acquisitor 503 and the bagging time corresponding to the attribute information acquired by the customer information acquisitor 505A. Further, the estimator 506A obtains a second time for which the customer puts commodities in a rolled bag, on the basis of the number of commodities likely to be put in the rolled bag among the commodity identification information acquired by the acquisitor 503 and a time for putting a commodity in the rolled bag corresponding to the attribute information acquired by the customer information acquisitor 505A.

The estimator 506A extracts content according to a total time of the first time and the second time from the content storage device 5021.

The content provider 508A causes the display device to display the content in a period during which the commodities are bagged in the shopping bag by the customer after settlement ends.

The content provider 508A causes the display device to display content having a highest priority ranking among the extracted content when the sensor detects that there is a customer even after all pieces of extracted content have been played back.

The communicator 501, the acquisitor 503, the store clerk information acquisitor 504, the customer information acquisitor 505A, the estimator 506A, the extractor 507, the content provider 508A, and the controller 509 may be configured with, for example, a processing device such as a central processor (CPU) or a dedicated electronic circuit.

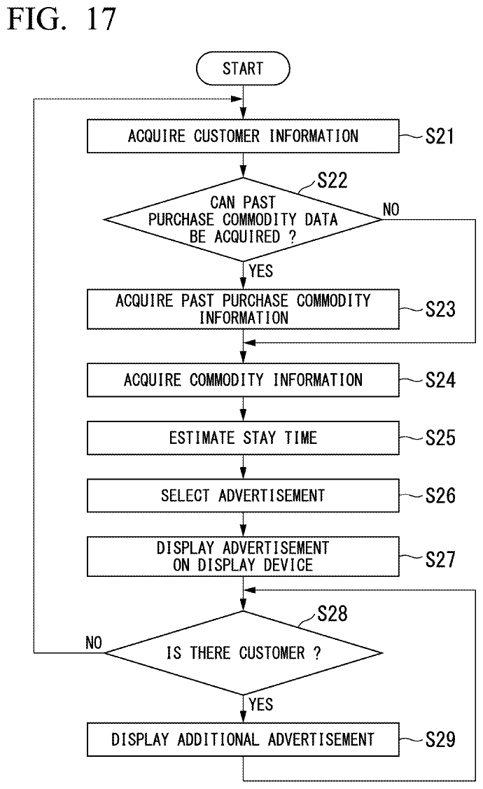

FIG. 17 is a flowchart illustrating an operation of the content management device 50A in the second embodiment.

### Step S21: Acquisition of Customer Information

When commodities to be purchased from commodities displayed in a store are put in a shopping basket and carried to the cash register counter by a customer, a store clerk performs an operation input of customer information. The operation input is an operation to read a barcode of the member's card 20 with the scanner 10 or an operation to press the customer group button for inputting the attribute of the customer disposed in the POS terminal 30.

The POS terminal 30 acquires the customer information by acquiring the customer identification information corresponding to the barcode or the attribute of the customer allocated to the pressed customer group button on the basis of the operation input. When the customer information is acquired, the POS terminal 30 transmits the acquired customer information to the content management device 50A.

The customer information acquisitor 505A of the content management device 50 acquires the customer information. When the acquired customer information is the customer identification information, the customer information acquisitor 505A can obtain the customer information by referring to the customer information storage device 5024 and reading out the date of birth and the sex registered in the membership registration on the basis of the customer identification information.

### Step S22: Determination of Acquisition Possibility of Past Purchase Data

In Step S22, the controller 509 determines whether past purchase commodity data can be acquired. In Step S2, when the barcode of the member's card is read with the scanner 10, the controller 509 determines that the purchase data can be acquired (Step S22—YES). In this case, the processing proceeds to Step S23.

On the other hand, in Step S21, when the customer attribute is obtained by pressing the customer group button, the controller 509 determines that the past purchase commodity data cannot be acquired (Step S22—NO). In this case, the processing proceeds to Step S24.

### Step S23: Acquisition of Past Purchase Commodity Information

When the customer identification information is obtained in Step S3, the customer information acquisitor 505A acquires the past purchase commodity information by referring to the customer information storage device 5024 and reading out purchase data corresponding to the customer identification information.

### Step S24: Acquisition of Commodity Information

In Step S24, the store clerk takes out one commodity in the shopping basket and reads the barcode attached to the taken-out commodity with the scanner 10. The scanner 10 reads the barcode attached to the commodity and outputs a reading result as commodity identification information to the POS terminal 30.

The store clerk sequentially puts the commodity of which commodity registration is completed, in the basket each time the barcode of the commodity is read.

With this, the POS terminal 30 sequentially acquires the commodity identification information each time the barcode is read with the scanner 10. The POS terminal 30 transmits the acquired commodity identification information to the content management device 50 each time the commodity identification information is acquired. The acquisitor 503 of the content management device 50 sequentially acquires the commodity identification information from the POS terminal 30. The controller 509 of the content management device 50 stores the received commodity identification information as the purchase data of the customer information storage device 5024.

Here, a commodity requiring an additional process such as hot food or a soft ice cream may not be a target to be purchased.

### Step S25: Estimation of Waiting Time

When the respective commodities to be purchased are read, the store clerk presses the “SUBTOTAL” button on the POS terminal 30. The POS terminal 30 performs settlement processing in response to the press of the “SUBTOTAL” button. Further, when the “SUBTOTAL” button is pressed, the POS terminal 30 transmits a registration completion signal representing that the registration of the commodity identification information is completed, to the content management device 50.

When the registration completion signal is received, the estimator 506A of the content management device 50 estimates a stay time. In the stay time, a bagging time and a work time for putting a commodity in a rolled bag may be included.

For example, the estimator 506A estimates a waiting time on the basis of the number of pieces of scanned commodity identification information, the number of commodities likely to be put in the rolled bag, and the customer identification information.

The estimator 506A can obtain the number of pieces of scanned commodity identification information by counting the number of pieces of commodity identification information acquired by the acquisitor 503 in Step S3.

The estimator 506A calculates a time for bagging the commodities to be purchased by reading out a bagging time and a time for putting a commodity in a rolled bag corresponding to the customer identification information acquired by the customer information acquisitor 505 and multiplying the read-out bagging time by the number of pieces of commodity identification information.

The estimator 506A calculates a time for putting commodities in rolled bags by multiplying the read-out time for putting a commodity in a rolled bag by the number of commodities likely to be put in a rolled bag.

Then, the estimator 506A calculates the stay time by totaling the time for bagging the commodities to be purchased and the time for putting the commodities in the rolled bags.

Here, because the bagging time and the time for putting a commodity in a rolled bag according to the customer identification information are obtained, in spite of a time taken by human work, the stay time according to the customer can be obtained taking into consideration the speed of bagging of the customer, the time for putting a commodity in a rolled bag, and the like.

A specific example of a case where a stay time is calculated is described below.

Here, a calculation example of bagging when a store is a supermarket, and work of putting at least one of purchased commodities in a rolled bag is required will be described.

### Example

Customer information: 40s female

Number of purchased commodities: 15 commodities

Number of commodities likely to use a rolled bag among purchased commodities: two commodities

Customer attribute: From past data, a bagging time per commodity is two seconds, and a time per commodity of work of pulling out a rolled bag and putting a commodity in the rolled bag is five seconds.

Estimated stay time: (2 seconds×15 commodities)+(5 seconds×2 commodities)=40 seconds

Here, even when the number of purchased commodities is 15, when there are only commodities having no likelihood of using a rolled bag, the stay time is 30 seconds; however, when two commodities having a likelihood to use a rolled bag are included, the stay time is 40 seconds, and it is estimated that the customer stays longer for ten seconds.

### Step S26: Selection of Advertisement

When the stay time is obtained, in Step S26, the extractor 507 of the content management device 50 extracts content according to the stay time and relevant to the purchase commodity information of the customer. The extractor 507 can extract content similarly to the processing of Step S7 in the first embodiment.

### Step S27: Display of Advertisement

Here, the customer performs a settlement procedure by making a payment according to a purchase amount in Step S25, and when settlement is completed, carries the basket in which the commodities of which commodity registration is completed are put, from the cash register counter to the bagging table BT. Here, a camera that images an area from the cash register counter to the bagging table is provided on a ceiling, the customer is imaged by the ceiling camera, a bagging table to which the customer that completes settlement moves is tracked, and a position of a movement destination is specified. Then, the ceiling camera notifies the content management device 50A of a bagging table of the movement destination and the position of the movement destination.

When a combination of content is extracted by the extractor 507, the content provider 508A causes the display device 70-7 or the display device 70-8 to display the extracted content such that the content is played back in order according to the priority rankings. Here, because the notification of the bagging table of the movement destination and the position of the movement destination is received from the ceiling camera, one of the display device 70-7 or the display device 70-8 is selected according to the position of the bagging table by specifying the bagging table of the movement destination and the position of the bagging table on the basis of the notification content, and the selected display device (for example, the display device 70-7) is caused to display the content.

The content is displayed in response to an input of an operation input indicating that the store clerk completes the procedure regarding settlement, to the POS terminal 30. The customer carries the basket in which the commodities of which commodity registration is completed are put, from the cash register counter to the bagging table BT in response to the completion of the procedure regarding settlement. For this reason, when the customer arrives at the bagging table BT, the display of the content is started. For this reason, the customer can watch the content while performing work of putting commodities in rolled bags as necessary or putting the commodities in the shopping bag. Further, because the content has a playback time period according to the number of purchased commodities or a time necessary for carrying out a process of putting the commodities in the rolled bags, it is possible to have the customer watch the content for the playback time period matching the stay time.

On the display device 70-7, for example, content is displayed as shown in FIG. 12.

### Step S28: Detection of Customer

At a given time (for example, five seconds) before a timing at which the playback of the content extracted in Step S26 ends, the controller 509 acquires a detection result from the sensor SE5 and determines whether a customer stays near the bagging table BT, on the basis of the detection result. The customer stays near the bagging table BT until bagging or the like is completed, and when bagging or the like is completed, the customer moves to a position away from the bagging table BT, and thereafter, leaves the store.

When there is no customer in the vicinity of the bagging table BT (Step S28—NO), the controller 509 instructs the content provider 508A not to display additional content. With this, the content provider 508A causes the display device to display content determined in advance until a next customer performs cash register reception, without displaying additional content. Then, the controller 509 transits the processing to Step S21.

### Step S10: Display of Additional Content

On the other hand, when there is a customer in the vicinity of the bagging table BT (Step S28—YES), the controller 509 instructs the content provider 508A to display additional content. When the instruction is received, the content provider 508A causes the display device 70-7 to display content that is not yet displayed, among the content extracted in Step S7. Here, the content provider 508A may cause the display device to display content having a highest priority ranking among the content that is extracted by the extractor 507 and not displayed.

According to the embodiment described above, in a store such as a convenience store or a supermarket, it is possible to estimate a waiting time that arises during accounting, and to select and display appropriate content capable of allowing information to be acquired to the maximum using the waiting time. The appropriate content is, for example, content that can be played back for a time within the range of the waiting time, and may be an advertisement including information meeting the need of the customer.

By carrying out the present invention, it is possible to finely estimate a waiting time that arises during accounting, and to provide an advertisement with an optimum information amount matching the estimated time. Further, it is possible to further increase an effect of an advertisement by changing the content of an advertisement for each trend of the customer.

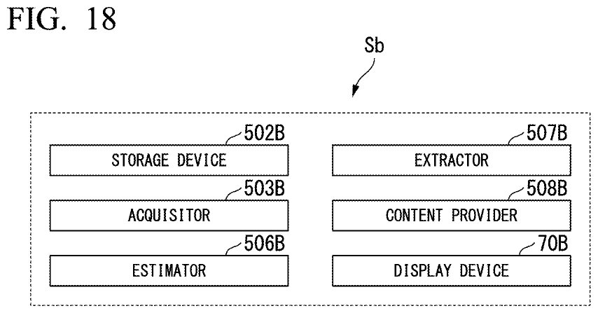

FIG. 18 is a schematic functional block diagram showing a configuration of a content management system Sb.

An acquisitor 503B acquires commodity identification information of commodities to be purchased and the presence or absence of additional work of the commodities based on a desire of a purchaser of the commodities.

The estimator 506B estimates a total work time on the basis of a bagging time for bagging the commodities to be purchased and an additional work time period required for the additional work of the commodities requiring the additional work among the commodities to be purchased. The work time may be one of a preparation time for which a store clerk of a store prepared a commodity in response to a request from a customer and a time for putting a commodity in a rolled bag. The preparation time may be determined according to the number of pieces of commodity identification information read with the scanner. The time for putting a commodity in a rolled bag may be determined according to the number of commodities likely to be put in a rolled bag among the commodities read with the scanner.

The additional work may be additional work (for example, work that arises in the cases (1) to (4) in the first embodiment) that arises when the store clerk provides a commodity in response to an order or the like of the commodity from the customer. Further, the additional work may be work in which a purchaser puts a commodity in a rolled bag.

The storage device 502B has a storage area functioning as a work time storage device that stores commodity identification information and an additional work time period required for additional work in association with each other.

The storage device 502B has a storage area functioning as a content storage device that stores content and a playback time period of the content.

The extractor 507B extracts content according to the total work time estimated by the estimator 506B from the storage device 502B. The extractor 507B may read out one piece of content or may extract a combination of content such that a total of playback time periods of a plurality of pieces of content becomes a time according to the total work time, as the content according to the total work time.

The content provider 508B causes a display device 70B visible to the customer to display the extracted content.

In the above-described embodiment, while a case where the content management device 50 or the content management device 50A is connected to the POS terminal 30 has been described, a part of functions of the content management device 50 or the content management device 50A may be provided in a stay time estimation device 80 that is an external device.

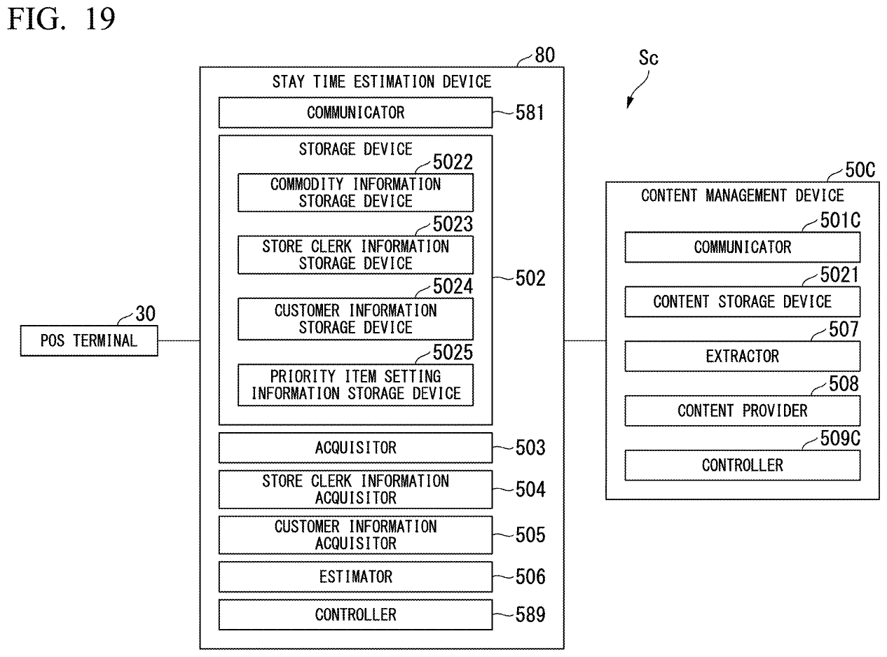

FIG. 19 is a schematic functional block diagram representing a configuration of a content management system Sc. In the content management system Sc, the POS terminal 30 and the stay time estimation device 80 are connected in a communicative manner, and the stay time estimation device 80 and a content management device 50C are connected in a communicative manner. In FIG. 19, functions corresponding to the functions of the content management device 50 of FIG. 3 are represented by the same reference numbers, and description of these functions will not be repeated.

The stay time estimation device 80 has a communicator 581, a storage device 502, an acquisitor 503, a store clerk information acquisitor 504, a customer information acquisitor 505, an estimator 506, and a controller 589. The communicator 581 has a function of performing communication with the POS terminal 30, and has a function of performing communication with the content management device 50C. The controller 589 controls each of the stay time estimation device 80.

The content management device 50C has a communicator 501C, a content storage device 5021, an extractor 507, a content provider 508, and a controller 509C. The communicator 501C has a function of communicating the stay time estimation device 80. The controller 509C controls each of the content management device 50C.

With such a configuration, for example, the processing of Steps S1 to S6 shown in FIG. 9 is executed by the stay time estimation device 80, and the estimated waiting time acquired in Step S6, the past purchase commodity information obtained in Step S2, and the commodity identification information obtained in Step S3 are transmitted to the content management device 50C. Then, the extractor 507 of the content management device 50C may extract an advertisement relevant to commodities purchased by the customer among content stored in the content storage device 5021.

Here, while a case where the functions of the content management device 50 are divided into the stay time estimation device 80 and the content management device 50C has been described, a part of functions of the content management device 50A shown in FIG. 14 may also be provided in the stay time estimation device similarly.

Processing management may be performed by recording a program for realizing the functions of the processors in FIG. 1 on a computer-readable recording medium and reading and executing the program recorded on the recording medium in a computer system. It is assumed that the “computer system” state herein includes an OS and hardware such as peripheral devices.

It is assumed that the “computer system” includes a homepage provision environment (or display environment) when a WWW system is used. Further, the “computer-readable recording medium” refers to a portable medium such as a flexible disk, a magneto-optical disk, a ROM, or a CD-ROM or a storage device such as a hard disk embedded in the computer system. In addition, it is assumed that the “computer-readable recording medium” includes a medium that holds the program for a given time like a volatile memory inside the computer system serving as a server or a client. The above-described program may be a program for realizing a part of the functions described above or may be a program that can realize the functions described above in combination with a program already recorded in the computer system. The above-described program may be stored in a predetermined server and the program may be distributed (downloaded or the like) via a communication line according to a request from other devices.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

5 Commodity
5a Commodity identification information
10 Scanner
20 Member's card
25 Store clerk's card
30, 30a, 30b POS terminal
40, 60 Router
50, 50A, 50C Content management device
70, 70-1, 70-2, 70-5, 70-6, 70-7, 70-8, 70B Display device
80 Stay time estimation device
501, 501C, 581 Communicator
502, 502B Storage device
503, 503B Acquisitor
504 Store clerk information acquisitor
505, 505A Customer information acquisitor
506, 506A, 506B Estimator
507, 507B Extractor
508, 508A, 508B Content provider
509, 509C, 589 Controller
5021 Content storage device
5022 Commodity information storage device
5023 Store clerk information storage device
5024, 5024A Customer information storage device
5025 Priority item setting information storage device
5026A Usage mode storage device
BT Bagging table
CLa, CLb Store clerk
CU1, CU2, CU3, CU21, CU22 Customer
NWa, NWb, NWc, NWd Network
POS Store clerk's card
RC Cashier counter
S, Sa, Sc Content management system
SE1, SE2, SE5 Sensor

What is claimed is:

1. A content management system comprising:
an acquisitor configured to acquire commodity identification information of commodities to be purchased and presence or absence of additional work of the commodities for a desire of a purchaser of the commodities;
a work time storage device configured to store the commodity identification information and an additional work time period required for the additional work, wherein the commodity identification information and the additional work time period are associated with each other;
an estimator configured to estimate a total work time on the basis of a bagging time required for bagging the commodities to be purchased and of the additional work time period required for the additional work of the commodities requiring the additional work among the commodities to be purchased;
a content storage device configured to store contents and a playback time period of the contents;
an extractor configured to extract contents according to the total work time period from the content storage device; and
a content provider configured to cause a display device visible to a customer to display the contents extracted.

2. The content management system according to claim 1,
wherein the work time storage device is configured to store at least the commodity identification information, a heating-work time necessary in case of heating foods with a cooking appliance, and a non-heating-work time necessary in case of not heating foods with the cooking appliance.

3. The content management system according to claim 1,
wherein the additional work includes a preparation time necessary for a store clerk of a store that sells the commodity to prepare the commodity in accordance with a request from a customer.

4. The content management system according to claim 3,
wherein the additional work time period includes at least one of:
a serving time until hot food ordered from the customer is taken out of a hot showcase and served to the customer,
a cooking time until a commodity ordered by the customer is cooked and handed over to the customer, and
an exchange time until a store clerk prepares a commodity in accordance with a coupon presented from the customer and hands over the commodity to the customer.

5. The content management system according to claim 1, further comprising:
a store clerk information acquisitor configured to acquire store clerk identification information that identifies a store clerk who performs cash register reception; and
a store clerk information storage device configured to store the bagging time, the additional work time period, and the store clerk identification information in association with one another,
wherein the estimator is configured to:
read out a bagging time for the commodity and the additional work time period from the store clerk information storage device on the basis of the store clerk identification information acquired by the store clerk information acquisitor; and
estimate the total work time on the basis of the read-out time.

6. The content management system according to claim 1, further comprising:
a content storage device that stores contents, a classification item representing a classification of the contents, and a playback time period of the content, wherein the contents, the classification item and the playback time period are associated with one another; and
a commodity information storage device that stores the commodity identification information attached to the commodity and the classification item indicating a classification allocated to the commodity, wherein the commodity identification information and the classification item are associated with each other,
wherein the extractor is configured to:
extract, from the content storage device, contents allocated with the item corresponding to the commodity identification information acquired by the acquisitor, and
extract a combination of playback time periods of a plurality of pieces of extracted contents, wherein a total of the playback time periods is within the total work time.

7. The content management system according to claim 6, further comprising:
a sensor configured to detect whether there is a customer who is a purchaser in the vicinity of a cash register who reads identification information of the commodity with a scanner,
wherein the content provider is configured to cause the display device to display anyone piece of the contents which has been extracted and has not yet been displayed, in case that the sensor detected that there is a customer even after all pieces of the contents extracted have been played back.

8. The content management system according to claim 1,
wherein the content provider is configured to:
cause the display device to display the content in a time period during which the commodity is bagged by a store clerk of a store that sells the commodity, after settlement of the commodity ends.

9. The content management system according to claim 1,
wherein the estimator is configured to:
estimate, as an additional work time period, a work time including a time taken for some commodities among the commodities to be packed in a rolled bag by a customer and a time taken for commodities to be bagged in a shopping bag by the customer, after settlement of the commodity ends.

10. The content management system according to claim 9,
wherein the display device is placed in the vicinity of a cash register and is placed on a table on which the customer performs bagging of commodities, and
the content provider is configured to:
cause the display device to display the contents in a period during which the commodities are bagged in the shopping bag by the customer, after the settlement ends.

11. The content management system according to claim 1, further comprising:
a customer information acquisitor configured to acquire attribute information of a customer who performs bagging;
a customer information storage device configured to store a first sub-time period for which each of the commodities is bagged in a shopping bag, a second sub-time period for which each of the commodities is put in a rolled bag, and an attribute of a customer, wherein the first time period, the second time period, and the attribute of the customer are associated with one another; and
a usage mode storage device that stores the commodity identification information and a usage mode indicating whether there is a likelihood of being put in the rolled bag, wherein the commodity identification information and the usage mode are associated with each other,
wherein the estimator is configured to:
obtain a first time period required for the customer to bag the commodities on the basis of the number of the commodities to be put in the shopping bag based on the commodity identification information acquired by the acquisitor and the first sub-time period for the bagging corresponding to the attribute information acquired by the customer information acquisitor,
obtain a second time period required for the customer to put the commodities in the rolled bag on the basis of the number of commodities to be put in the rolled bag based on the commodity identification information acquired by the acquisitor and the second sub-time period for putting each of the commodities in the rolled bag, corresponding to the attribute information acquired by the customer information acquisitor, and
extract contents according to a total time of the first time period and the second time period from the content storage device.

12. The content management system according to claim 10, further comprising:
a sensor configured to detect whether there is a customer who is a purchaser, near a table on which the bagging is performed,
wherein the content provider is configured to cause the display device to display one piece of the contents extracted in case that the sensor detected that there is a customer even after all pieces of the contents extracted have been played back.

13. The content management system according to claim 11, further comprising:
a sensor configured to detect whether there is a customer who is a purchaser, near a table on which the bagging is performed,
wherein the content provider is configured to cause the display device to display one piece of the contents extracted in case that the sensor detected that there is a customer even after all pieces of the contents extracted have been played back.

14. A content display method comprising:
acquiring commodity identification information of commodities to be purchased and presence or absence of additional work of the commodities for a desire of a purchaser of the commodities;
estimating a total work time on the basis of a bagging time required for bagging the commodities to be purchased read out from a work time storage device that stores the commodity identification information and of an additional work time period required for the additional work of the commodities requiring the additional work among the commodities to be purchased, wherein the commodity identification information and the additional work time period are associated with each other;
extracting content according to the total work time from a storage device configured to store contents and a playback time period of the contents by referring to the storage device; and
causing a display device visible to a customer to display the contents extracted.
